(19) United States
(12) Patent Application Publication
(10) Pub. No.: US 2025/0256728 A1
(43) Pub. Date: Aug. 14, 2025

(54) DRIVING ASSISTANCE DEVICE AND DRIVING ASSISTANCE METHOD

(71) Applicant: TOYOTA JIDOSHA KABUSHIKI KAISHA, Toyota-shi (JP)

(72) Inventor: Masakazu NISHIJIMA, Ebina-shi (JP)

(73) Assignee: TOYOTA JIDOSHA KABUSHIKI KAISHA, Toyota-shi (JP)

(21) Appl. No.: 19/002,190

(22) Filed: Dec. 26, 2024

(30) Foreign Application Priority Data
Feb. 13, 2024 (JP) 2024-019501

(51) Int. Cl. B60W 50/00

(52) U.S. Cl. CPC B60W 50/0098; B60W 2050/0083; B60W 2552/53; B60W 2554/4029; B60W 2554/4044

(57) ABSTRACT

A driving assistance device performs driving assistance for a vehicle when a predetermined target is present in a driving assistance zone that is set on the front side of the vehicle. The driving assistance device is able to change the setting of area of the driving assistance zone. The driving assistance device is configured to, when the setting of the area of the driving assistance zone at the time of detection of a crosswalk on the front side of the vehicle is changeable in an enlarging direction, enlarge the area of the driving assistance zone so as to expand in an outward direction of the vehicle and encompass an entire zone of the driving assistance zone at the time of detection of the crosswalk.

### CROSS-REFERENCE TO RELATED APPLICATION

This application claims priority to Japanese Patent Application No. 2024-019501 filed on Feb. 13, 2024, incorporated herein by reference in its entirety.

### BACKGROUND

### 1. Technical Field

The present disclosure relates to a driving assistance device and a driving assistance method.

### 2. Description of Related Art

Japanese Unexamined Patent Application Publication No. 2009-271766 (JP 2009-271766 A) discloses, as a conventional obstacle detection device, a device that, when a crosswalk is present in an obstacle detection region that is set on the front side of an own vehicle, changes the shape of the obstacle detection region into a shape adapted to the shape of the crosswalk. Specifically, when a crosswalk is present in the obstacle detection region set on the front side of the own vehicle, this conventional obstacle detection device enlarges the left-right width of the obstacle detection region on the crosswalk according to the left-right width of the crosswalk.

### SUMMARY

However, on a crosswalk, a plurality of white lines extending in a front-rear direction that constitutes the crosswalk is present at intervals and thus the plurality of white lines and the silhouette of a pedestrian are present in a mixed state. For this reason, detecting a pedestrian on a crosswalk is relatively difficult in the first place, which may result in a delay in detecting the pedestrian.

Having been developed with a focus on this problem, the present disclosure aims to reduce the likelihood of a delay in detecting a predetermined target on the front side of an own vehicle.

To solve the above-described challenge, a driving assistance device according to one aspect of the present disclosure that performs driving assistance for a vehicle when a predetermined target is present in a driving assistance zone that is set on the front side of the vehicle is able to change the setting of area of the driving assistance zone.

The driving assistance device is configured to, when the area of the driving assistance zone at the time of detection of a crosswalk on the front side of the vehicle is changeable in an enlarging direction, enlarge the area of the driving assistance zone so as to expand in an outward direction of the vehicle and encompass an entire zone of the driving assistance zone at the time of detection of the crosswalk.

A driving assistance method according to another aspect of the present disclosure that performs driving assistance for a vehicle when a predetermined target is present in a driving assistance zone that is set on the front side of the vehicle permits the setting of area of the driving assistance zone to be changed. When the area of the driving assistance zone at the time of detection of a crosswalk on the front side of the vehicle is changeable in an enlarging direction, the driving assistance method enlarges the area of the driving assistance zone so as to expand in an outward direction of the vehicle and encompass an entire zone of the driving assistance zone at the time of detection of the crosswalk.

According to these aspects of the present disclosure, the driving assistance zone is enlarged upon detection of a crosswalk, which can reduce the likelihood of a delay in detecting the predetermined target.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a driving assistance device according to one embodiment of the present disclosure;

FIG. 2A is a view showing one example of a driving assistance zone that is set on a right front side of an own vehicle;

FIG. 2B is a view showing one example of the driving assistance zone that is set on a left front side of the own vehicle; and

FIG. 3 is a flowchart for describing setting control of the driving assistance zone according to one embodiment of the present disclosure.

### DETAILED DESCRIPTION OF EMBODIMENTS

An embodiment of the present disclosure will be described in detail below with reference to the drawings. In the following description, similar constituent elements will be denoted by the same reference numbers.

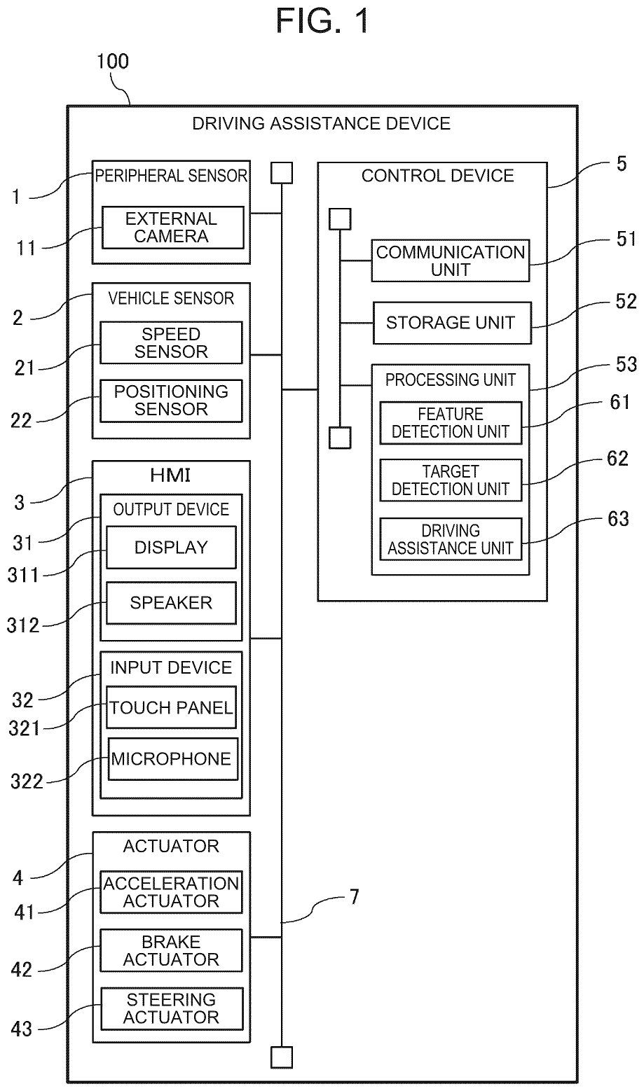

FIG. 1 is a schematic configuration diagram of a driving assistance device 100 according to one embodiment of the present disclosure.

The driving assistance device 100 includes a peripheral sensor 1, a vehicle sensor 2, a human-machine interface (HMI) 3, an actuator 4, and a control device 5. The peripheral sensor 1, the vehicle sensor 2, the HMI 3, the actuator 4, and the control device 5 are communicably connected to one another through an in-vehicle network 7 complying with a standard, such as a controller area network.

The peripheral sensor 1 is a sensor for generating peripheral data showing conditions around a vehicle for which driving assistance is performed by the driving assistance device 100 (hereinafter referred to as an “own vehicle”). In this embodiment, as the peripheral sensor 1, one or more external cameras 11 for imaging surroundings of the own vehicle including a front side of the own vehicle are included.

The external camera 11 images the surroundings of the own vehicle at a predetermined frame rate (e.g., 10 [Hz] to 40 [Hz]) and generates a surroundings image in which the surroundings of the own vehicle appear. Each time the external camera 11 generates a surroundings image, the external camera 11 transmits the generated surroundings image to the control device 5 as the peripheral data.

Instead of the external camera 11 or in addition to the external camera 11, a distance measuring sensor that measures a distance to a target, such as a vehicle or a pedestrian, present around the own vehicle may be included as the peripheral sensor 1. Examples of the distance measuring sensor include a light detection and ranging (LiDAR) that emits radar light and measures a distance based on reflected light, and a millimeter-wave radar sensor that emits electric waves and measures a distance based on reflected waves.

The vehicle sensor 2 is a sensor that generates vehicle data showing conditions of the own vehicle. In this embodiment, as the vehicle sensor 2, a speed sensor 21 that generates speed data showing a traveling speed of the own vehicle, a positioning sensor 22 that generates current position data showing a current position, such as a latitude and a longitude, of the own vehicle, etc. are included. However, the vehicle sensor 2 is not limited to these sensors. The vehicle sensor 2 transmits each acquired data to the control device 5 as the vehicle data.

The HMI 3 is a user interface for exchanging information between the own vehicle and an occupant thereof. The HMI 3 includes an output device 31 for making notifications to the occupant of the vehicle through the physical sense (e.g., the visual sense, the auditory sense, or the tactile sense) of the occupant of the vehicle, and an input device 32 for the occupant of the vehicle to perform an input operation and a response operation. In this embodiment, as the output device 31, displays (e.g., a meter display, a center display, and a head-up display) 311 and a speaker 312 are included, and as the input device 32, a touch panel 321 and a microphone 322 are included.

The HMI 3 displays information (e.g., character information or image information) according to a display signal received from the control device 5 on the displays 311, and outputs a voice according to a voice signal from the speaker 312. The HMI 3 transmits, to the control device 5, data that the occupant of the vehicle has inputted by panel operation or voice through the input device 32 (hereinafter referred to as “occupant-inputted data”).

The HMI 3 may be one that is pre-installed in the own vehicle, or may be a terminal, such as a smartphone, that the occupant of the vehicle possesses. In the latter case, for example, short-range wireless communication may be performed between the own vehicle and the terminal of the occupant of the vehicle to exchange information, or communication may be performed between the terminal of the occupant of the vehicle and an external server (not shown) to exchange information indirectly through the server.

The actuator 4 is a device that is used for travel control of the own vehicle. In this embodiment, as the actuator 4, an acceleration actuator 41 (e.g., at least either an engine or a motor) that performs acceleration control of the own vehicle, a brake actuator 42 (e.g., a hydraulic actuator) that performs brake control of the own vehicle, and a steering actuator 43 (e.g., a steering motor) that performs steering control of the own vehicle are included.

The control device 5 is an electronic control unit (ECU) including a communication unit 51, a storage unit 52, and a processing unit 53.

The communication unit 51 includes an interface circuit for connecting the control device 5 to the in-vehicle network 7. The communication unit 51 supplies various data received from the sensors 1, 2, the HMI 3, etc. to the processing unit 53. The communication unit 51 outputs various signals output from the processing unit 53 to the HMI 3, the actuator 4, etc.

The storage unit 52 has a storage medium, such as a hard disk drive (HDD), a solid disk drive (SDD), or a semiconductor memory, and stores various computer programs, data, etc. that are used for processing in the processing unit 53.

The processing unit 53 has one or more central processing units (CPUs) and their peripheral circuits, and executes the various computer programs stored in the storage unit 52. The processing unit 53 is, for example, a processor. The processing unit 53 may further have another arithmetic circuit, such as a logical operation unit, a numerical operation unit, or a graphic processing unit. By executing processing according to the computer programs, the processing unit 53 functions as a feature detection unit 61, a target detection unit 62, and a driving assistance unit 63 and operates as a functional unit (module) that realizes predetermined functions. In the following description, when processing is described with one of the functional units 61 to 63 as the subject, this means that the processing unit 53 is executing a program for realizing that one of the functional units 61 to 63.

In the following, the specific contents of processing executed in the control device 5 will be described. That is, the contents of the functional units 61 to 63 that are realized as the processing unit 53 executes the processing according to the programs will be described.

The feature detection unit 61 detects a feature based on the peripheral data received from the peripheral sensor 1. In this embodiment, the feature detection unit 61 detects a crosswalk on a front side based on the surroundings image received from the external camera 11. The feature detection unit 61 can detect a crosswalk on the front side based on the surroundings image received from the external camera 11 using, for example, 30 an image recognition technique such as pattern matching or semantic segmentation. When the feature detection unit 61 has detected a crosswalk, the feature detection unit 61 detects crosswalk data relating to that crosswalk. The crosswalk data includes, for example, a distance to the crosswalk. The distance to the crosswalk can be detected based on, for example, a distance of a Y coordinate (ordinate) in the surroundings image in which the crosswalk has been detected, or the size of a crosswalk region extracted from the surroundings image by image recognition.

The feature detection unit 61 can also detect a crosswalk on the front side by, for example, inputting the surroundings image received from the external camera 11 into a discriminator that has been trained beforehand to detect a crosswalk. Thus, the feature detection method is not particularly limited, and commonly known various technique can be used for the detection.

The target detection unit 62 detects a target that is present around the own vehicle based on the peripheral data received from the peripheral sensor 1. For example, by sequentially inputting the surroundings images received from the external camera 11 into a discriminator, the target detection unit 62 detects a region in the surroundings images where a target, such as a vehicle, a motorcycle, a pedestrian, a traffic light, or a building, appears, and the type of the target appearing in that region. The discriminator can be, for example, a convolutional neural network (CNN) having a plurality of convolution layers that is connected in series from an input side toward an output side. The target detection unit 62 calculates the position and the speed of the target by estimating a distance from the external camera 11 to the target using a corresponding one of standard sizes of targets that are stored in the storage unit 52 by the type of target and the size of the target detected in the surroundings image, and tracking the target detected in the surroundings images in chronological order. The target detection method is not limited to this method, and commonly known various techniques can be used for the detection.

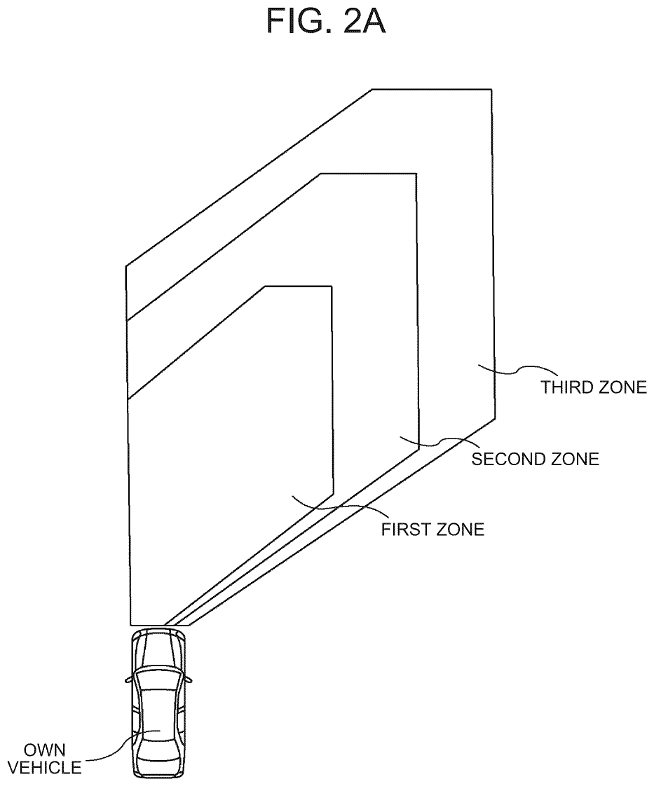

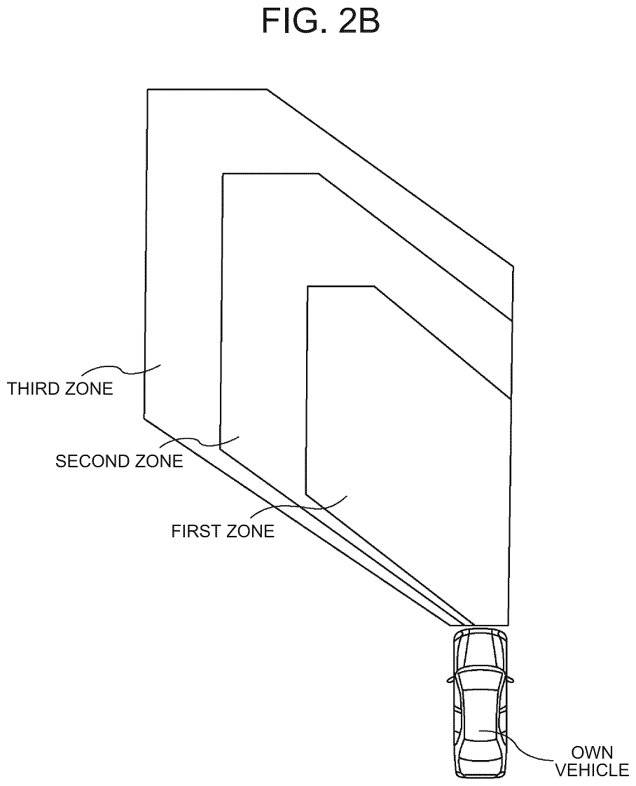

When a predetermined target is present in a driving assistance zone (see FIG. 2A and FIG. 2B) that is set on the front side of the own vehicle, the driving assistance unit 63 performs driving assistance for a driver of the own vehicle. The predetermined target is a mobile body, such as a pedestrian or a motorcycle, that is moving in a direction toward the own vehicle and may travel on a crosswalk. As the driving assistance for the driver, the driving assistance unit 63 can, for example, make a notification for warning and a notification for prompting deceleration by the HMI 3. Further, as the driving assistance for the driver, the driving assistance unit 63 can also perform travel control (e.g., deceleration, circumventive steering) of the own vehicle by the actuator 4, for example, in addition to or instead of notifications by the HMI 3.

In the following, the driving assistance by the driving assistance unit 63 will be described in more detail with reference to FIG. 2A and FIG. 2B.

FIG. 2A and FIG. 2B are views showing one example of the driving assistance zone set on a right front side and a left front side of the own vehicle.

As shown in FIG. 2A and FIG. 2B, the shape of the driving assistance zone set on the right front side and the left front side of the own vehicle is bilaterally symmetrical, and area thereof can be changed stepwise or steplessly according to the driver's preferences. In this embodiment, the driving assistance zone can be changed in three levels of a first zone, a second zone, and a third zone, in increasing order of area.

The first zone is a predetermined zone on the right front side and the left front side of the own vehicle. The second zone is a zone that is obtained by enlarging the first zone so as to expand in an outward direction of the own vehicle and encompass the entire first zone. The third zone is a zone that is obtained by enlarging the second zone so as to expand in the outward direction of the own vehicle and encompass the entire second zone.

The driving assistance zone is set by default to the third zone that has largest area. The larger the area of the driving assistance zone is made, the earlier a predetermined target present on the right front side or the left front side of the own vehicle can be detected, but the frequency of intervention by the driving assistance increases accordingly. For this reason, some drivers may feel that the driving assistance zone is too large and set the driving assistance zone to the second zone or the first zone.

On the other hand, on a crosswalk, a plurality of white lines extending in a front-rear direction that constitutes the crosswalk is present at intervals and thus the plurality of white lines and the silhouette of a pedestrian are present in a mixed state. For this reason, detecting a pedestrian on a crosswalk is relatively difficult in the first place, which may result in a delay in detecting the pedestrian.

Therefore, when there is a crosswalk on the front side, it is desirable to be able to detect a pedestrian as early as possible. To this end, in this embodiment, when the driving assistance zone at the time of detection of a crosswalk on the front side is not the third zone, the driving assistance zone is temporarily changed to the third zone.

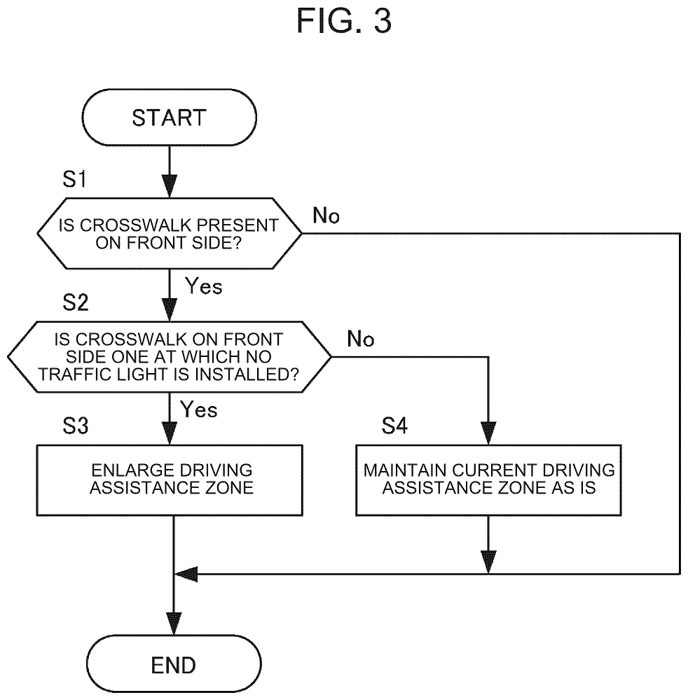

FIG. 3 is a flowchart for describing setting control of the driving assistance zone according to this embodiment that is performed by the driving assistance unit 63 and therefore by the control device 5. The control device 5 executes this routine repeatedly on a predetermined arithmetic operation cycle ΔT.

In step S1, the control device 5 determines whether a crosswalk is present on the front side based on a detection result of the feature detection unit 61. When a crosswalk is present on the front side, the control device 5 proceeds to processing of step S2. On the other hand, when a crosswalk is not present on the front side, the control device 5 ends the current processing.

In step S2, the control device 5 determines whether the crosswalk on the front side is a crosswalk at which no traffic light is installed. When the crosswalk on the front side is a crosswalk at which no traffic light is installed, the control device 5 proceeds to processing of step S3. On the other hand, when the crosswalk on the front side is a crosswalk at which a traffic light is installed, the control device 5 proceeds to processing of step S4.

Whether the crosswalk on the front side is a crosswalk at which no traffic light is installed can be determined based on, for example, a crosswalk detection result of the feature detection unit 61 and a traffic light detection result of the target detection unit 62. In this embodiment, when a traffic light has not been detected by the target detection unit 62 within a range of a predetermined front-rear distance from the crosswalk detected by the feature detection unit 61, the control device 5 determines that the crosswalk is a crosswalk at which no traffic light is installed.

In this embodiment, the reason for determining whether a traffic light is installed at a crosswalk is as follows: While a contact accident involving a mobile body moving on a crosswalk is highly likely to occur particularly at a crosswalk at which no traffic light is installed, enlarging the driving assistance zone against the driver's intentions at a crosswalk at which a traffic light is installed may cause the driver to feel annoyed by the driving assistance as the frequency of unnecessary intervention by the driving assistance, for example, performing the driving assistance in response to a pedestrian etc. waiting for a traffic light, increases.

In step S3, when the driving assistance zone is not set to the third zone, the control device 5 temporarily enlarges the driving assistance zone. In this embodiment, the control device 5 temporarily changes the driving assistance zone to the third zone. The driving assistance zone that has been temporarily changed is returned to the original zone, for example, at a point when the own vehicle has passed through the crosswalk.

In step S4, the control device 5 leaves the driving assistance zone as it is currently set.

The driving assistance device 100 according to this embodiment having been described above performs the driving assistance for the vehicle when a predetermined target is present in the driving assistance zone set on the front side of the vehicle. The driving assistance device is able to change the setting of the area of the driving assistance zone. The driving assistance device is configured to, when the area of the driving assistance zone at the time of detection of a crosswalk on the front side of the vehicle is changeable in the enlarging direction, enlarge the area of the driving assistance zone so as to expand in the outward direction of the vehicle and encompass the entire zone of the driving assistance zone at the time of detection of the crosswalk. The predetermined target is, for example, a mobile body, such as a pedestrian, that can travel on a crosswalk and is moving in a direction toward the vehicle.

Thus, the driving assistance zone is enlarged upon detection of a crosswalk on the front side of the vehicle, which can reduce the likelihood of a delay in detecting a specific target that is covered by the driving assistance. As a result, the likelihood of a delay in an activation timing of the driving assistance can also be reduced.

In particular, in this embodiment, the area of the driving assistance zone is enlarged so as to expand in the outward direction of the vehicle and encompass the entire zone of the driving assistance zone at the time of detection of the crosswalk. Thus, in some cases, a specific target, such as a pedestrian, that is traveling on a sidewalk on a farther outer side of the crosswalk on the road, i.e., a specific target that is about to travel on the crosswalk can be captured inside the driving assistance zone. In this case, there is no need to detect the specific target on the crosswalk, so that the likelihood of degradation of the accuracy in detecting that target can be reduced. Accordingly, the likelihood of a delay in detecting the specific target can be reduced.

The driving assistance device 100 according to this embodiment is configured to, when the area of the driving assistance zone at the time of detection of a crosswalk on the front side of the vehicle is not the largest settable area, enlarge the area of the driving assistance zone to the largest settable area.

Thus, when a crosswalk is detected on the front side, the driving assistance zone can be maximally enlarged to thereby reduce the likelihood of a delay in detecting a specific target that is covered by the driving assistance.

In this embodiment, a crosswalk that is covered by the driving assistance is a crosswalk at which no traffic light is installed. Thus, the likelihood of unnecessarily performing the driving assistance, such as performing the driving assistance in response to a pedestrian etc. waiting for a traffic light, can be reduced. Accordingly, the likelihood of the driver feeling annoyed by the driving assistance can be reduced.

While the embodiment of the present disclosure has been described above, the above-described embodiment has merely shown some of examples of application of the present disclosure and is not intended to restrict the technical scope of the present disclosure to the specific configuration of the above-described embodiment.

For example, in the above-described embodiment, the driving assistance zone is enlarged to the largest third zone upon detection of a crosswalk on the front side; however, instead of being enlarged to the maximum, the driving assistance zone may be enlarged so as to be larger than the area at the time of detection of a crosswalk on the front side.

For example, in the above-described embodiment, the computer programs executed in the control device 5 may be provided in a form of being recorded in a computer-readable portable recording medium, such as a semiconductor memory, a magnetic recording medium, or an optical recording medium.

What is claimed is:

1. A driving assistance device that performs driving assistance for a vehicle when a predetermined target is present in a driving assistance zone that is set on a front side of the vehicle, wherein:
the driving assistance device is able to change setting of area of the driving assistance zone; and
the driving assistance device is configured to, when the setting of the area of the driving assistance zone at a time of detection of a crosswalk on the front side of the vehicle is changeable in an enlarging direction, enlarge the area of the driving assistance zone so as to expand in an outward direction of the vehicle and encompass an entire zone of the driving assistance zone at the time of detection of the crosswalk.

2. The driving assistance device according to claim 1, wherein, the driving assistance device is configured to, when the area of the driving assistance zone at the time of detection of a crosswalk on the front side of the vehicle is not largest settable area, enlarge the area of the driving assistance zone to the largest settable area.

3. The driving assistance device according to claim 1, wherein the crosswalk is a crosswalk at which no traffic light is installed.

4. The driving assistance device according to claim 1, wherein the predetermined target is a mobile body that is able to travel on the crosswalk and is moving in a direction toward the vehicle.

5. A driving assistance method that performs driving assistance for a vehicle when a predetermined target is present in a driving assistance zone that is set on a front side of the vehicle, wherein:
the driving assistance method permits setting of area of the driving assistance zone to be changed; and
when the area of the driving assistance zone at a time of detection of a crosswalk on the front side of the vehicle is changeable in an enlarging direction, the driving assistance method enlarges the area of the driving assistance zone so as to expand in an outward direction of the vehicle and encompass an entire zone of the driving assistance zone at the time of detection of the crosswalk.
